(19) United States
(12) Patent Application Publication
(10) Pub. No.: US 2007/0235486 A1
(43) Pub. Date: Oct. 11, 2007

(54) Motorcycle side carrier box

(76) Inventor: Tim Bernard, Boise, ID (US)

Correspondence Address: PEDERSEN & COMPANY, PLLC, P.O. BOX 2666, BOISE, ID, 83701, US

(21) Appl. No.: 11/401,595

(22) Filed: Apr. 10, 2006

(51) Int. Cl. B60R 9/00; B60R 7/00; B62J 9/00

(52) U.S. Cl. 224/400; 224/557; 224/413

(57) ABSTRACT

A storage container for personal items, tools, gear, and the like, that can be mounted to a motorcycle or other recreational vehicle. A lid fits to the top of the container and is attached to the containment body with slide-hinges on either end of one side of the containment body. The lid is able to raise vertically above the containment body for the distance allowed by the bolt and slide-hinge arrangement, then pivot over to one side of the containment body, for ease in packing and retrieving objects inside the box. The lid can be latched tightly over the containment body by way of locks at each end. The lid rests against a rubber sealing ring around the opening of the containment body to provide a tight seal for protecting the contents inside the box against elements. In its fully open state, the lid can support small items.

### BACKGROUND OF THE INVENTION

1. Field of the Invention

This invention relates to storage containers and, more specifically, to lidded storage containers mounted on a motorcycle or other type of recreational vehicle.

2. Description of the Related Art

When transporting small or lightweight objects on a motorcycle, boat, pickup truck, or similar open-air vehicle, it is necessary to have a secured storage container so as not to lose or damage items. It may also be necessary to have a sealed, airtight container to prevent natural elements, such as water, wind, or dust, from damaging the objects inside the storage container. Many different locks and hinges are available for securing a lid to a box, but some may be more ideal for particular uses and functions than others.

Visenzi, U.S. Pat. No. 5,351,509, describes a device for closing and coupling luggage and the like, particularly for motorcycles. A locking plate is provided with a lock and bolt mechanism for closing the device and with an opening for permitting uncoupling of the carryall case from a motorcycle.

Walter et al., U.S. Pat. No. 5,439,149, describes a storage case for a motorcycle which can be fixed on a carrier strip and which comprises a basic housing, a lid pivotally connected to the basic housing, and a constructional unit. A lock is installed into the constructional unit which provides that the device for the fixing of the basic housing on the vehicle frame and/or the device for the locking of the lid with the basic housing can be locked.

Akutsu, U.S. Pat. No. 5,857,600, describes a portable case for belongings which consists of a case body of leather and a cover lid of metal to protect the belongings within the case body. The case body and protective lid are hinged together and are disengageable from each other at the hinge so that both case body itself and cover lid can be replaced with new ones.

Lance et aL, U.S. Pat. No. 6,203,087, describes a vehicle mounted storage unit, adapted to be mounted to a floor portion of a vehicle having a side wall and a wheel well. The cabinet is adapted to be mounted adjacent the side wall of the vehicle and adjacent the wheel well, with no portion of the cabinet extending beyond the wheel well of the vehicle.

Cheney, U.S. Pat. No. 6,386,409, describes a vehicle storage box with single hinged double secured compartments and dual actuating cam latches, in which the lid is pivotally connected to a base structure.

Lance et al., U.S. Pat. No. 6,422,629, describes a vehicle mounted storage unit, adapted to be mounted to a floor portion of a vehicle having a sidewall and wheel well, and provided with a quick-release mechanism that facilitates attachment of the cabinet to the mounting bracket and release of the cabinet from the mounting bracket.

Fang, U.S. Pat. No. 6,631,835, describes an object storing case of a motorcycle that includes a connecting part that is disposed in a recess of a rear side of a holding body thereto, a fixing plate pivoted to the connecting part at the middle, a locking member and an operating member.

Monson, U.S. Pat. No. 6,820,782, describes a releasable saddlebag system for motorcycles in which a mounting structure enables quick removal of the saddlebag without the use of tools. The mounting structure includes a mounting bolt attached to the motorcycle, and a mounting pin carrying the saddlebag. Removal of the saddlebag occurs by simply removing the mounting pin.

A primary objective of the present invention is to provide a durable, lidded storage container for open-air recreational vehicles, such as a motorcycle, a boat, or a pickup truck.

Another objective of the present invention is to provide a storage container that is easily mountable to and dismountable from a recreational vehicle.

Another objective of the present invention is to provide a storage container with a lid that pivots all the way over to the side for ease in packing and unpacking items from the container, but that does not detach completely from the container so as not to become misplaced, forgotten, stolen, or otherwise lost.

Another objective of the present invention is to provide a sealed, wind and water resistant storage container to store items that may be damaged by wind, water, or dust.

### BRIEF SUMMARY OF THE INVENTION

The present invention is a motorcycle storage container for personal items, tools, gear, and the like, which is made of a durable material, such as metal, that can withstand rough handling. A lid fits to the top of the container and is connected to the container body with bolts and slide-hinges on the ends of the container body. The lid is able to raise vertically above the containment body for the distance allowed by the bolt and slide-hinge arrangement, then pivot over to the other side of the containment body, for ease in packing and retrieving objects inside the box. The lid can be latched tightly over the containment body by way of two cam locks, one at each end, or by other methods that allow clamping of the lid to the containment body. The position of the locks must be in a location on the containment body to allow a clamping effect of the lid. The lid rests against a rubber sealing ring around the opening of the containment body to provide a secure, tight seal for protecting the contents inside the box against elements, such as water, wind, and dust. The containment body attaches to a recreational vehicle through bolts in one side wall of the containment body. The top of the lid has loops that allow a user to pass strapping material, such as rope or webbing, through the loops and tie additional objects to the top of the box.

### BRIEF DESCRIPTION OF THE DRAWINGS

FIG. 1 is a side partial view of one embodiment of the present invention attached to a vehicle.

FIG. 2 is a top, side perspective view of the present invention with the lid closed.

FIG. 3 is a top, side perspective view of the present invention with the lid open.

FIG. 4 is a first side view of the present invention.

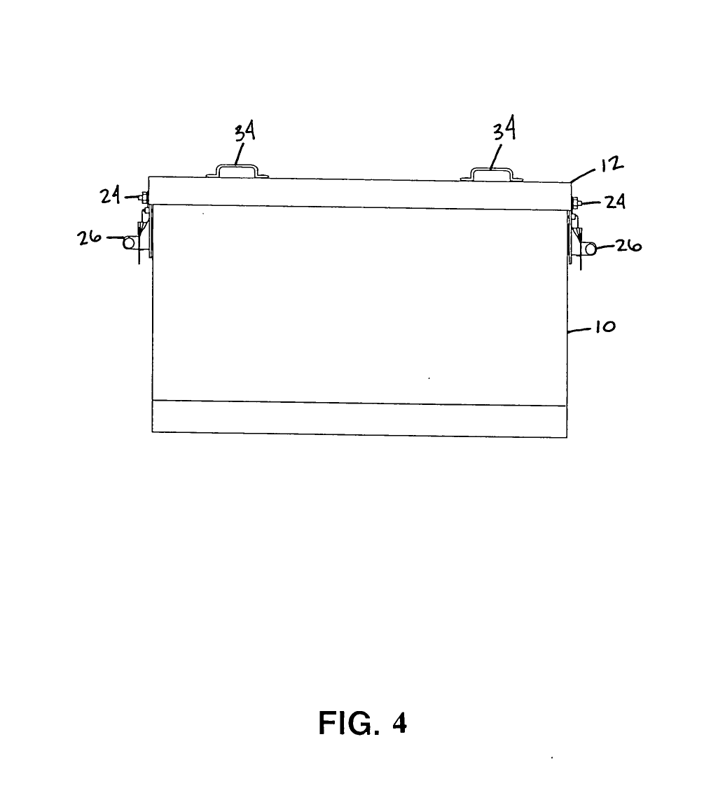

FIG. 5 is the other side view of the present invention.

FIG. 6 is a front view of the present invention that shows the slide-hinge lid and cam lock.

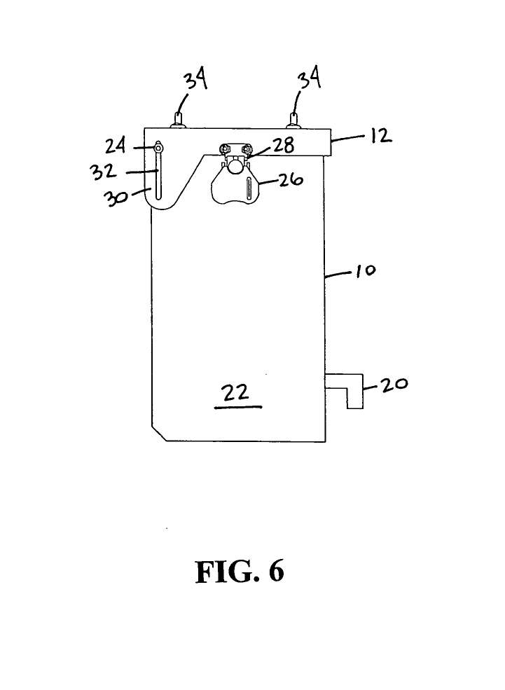

FIG. 7 is a front view of the invention depicted in FIG. 6 that shows the open slide-hinge lid.

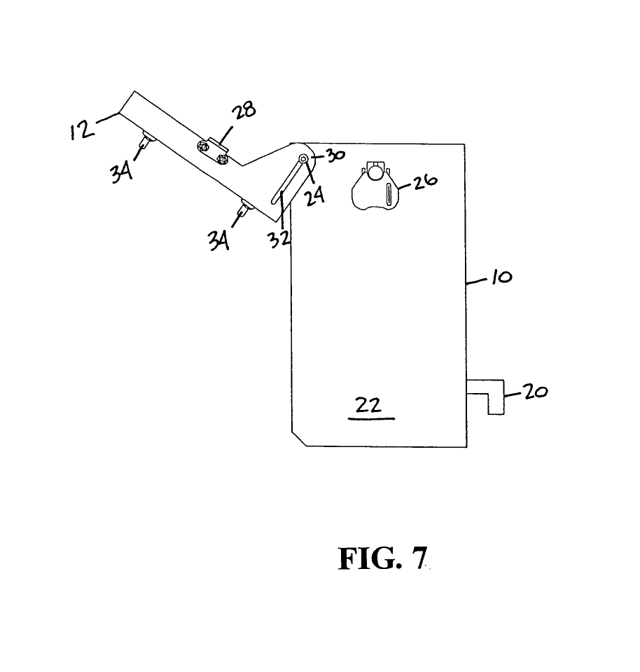

FIG. 8 is a front, cross-sectional view of the invention in FIG. 7 showing the lid action and the rubber sealing ring.

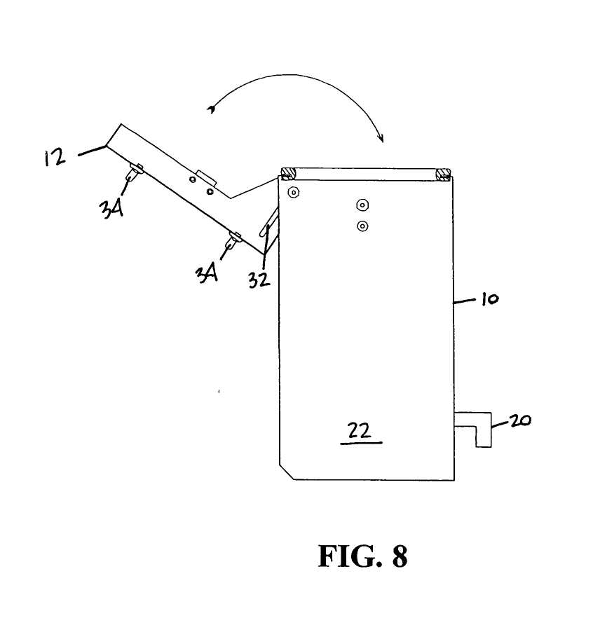

### DETAILED DESCRIPTION OF THE INVENTION

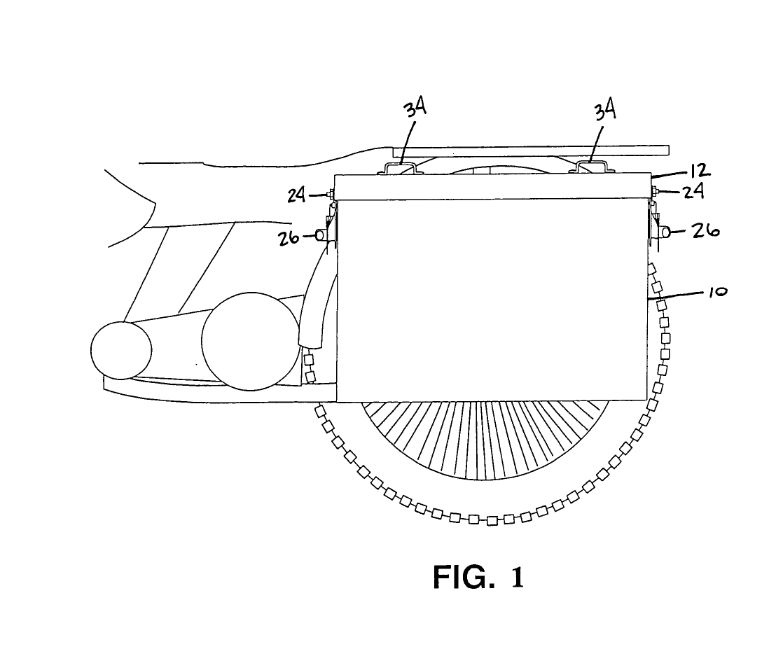

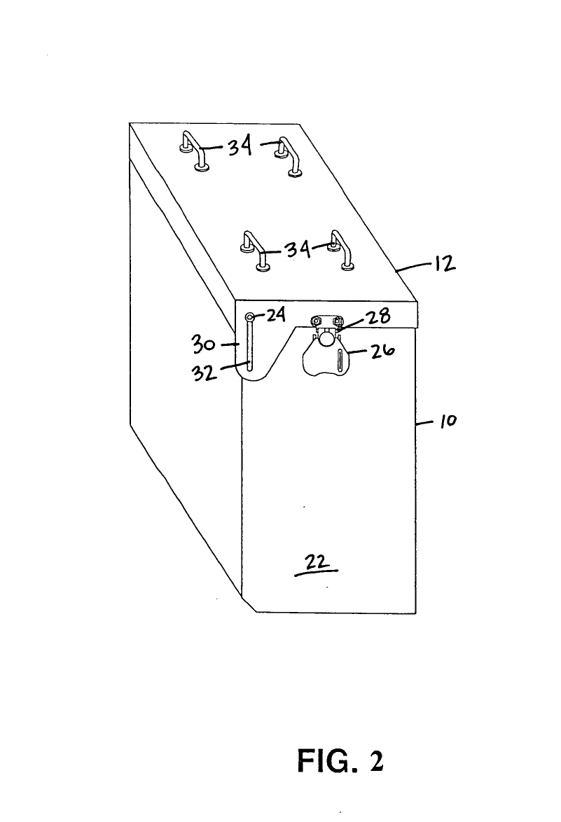

One embodiment of the present invention, a motorcycle side carrier box for the storage and transportation of personal items, tools, gear, and the like, is depicted in FIG. 1. The box has a containment body (10) with an open top, and a lid (12) that fits over and around the top of the containment body (10), best illustrated in FIG. 2. The containment body (10) has two vertical side walls, two vertical ends, and one horizontal bottom wall that are joined together at their edges, and made of metal or other similarly durable material.

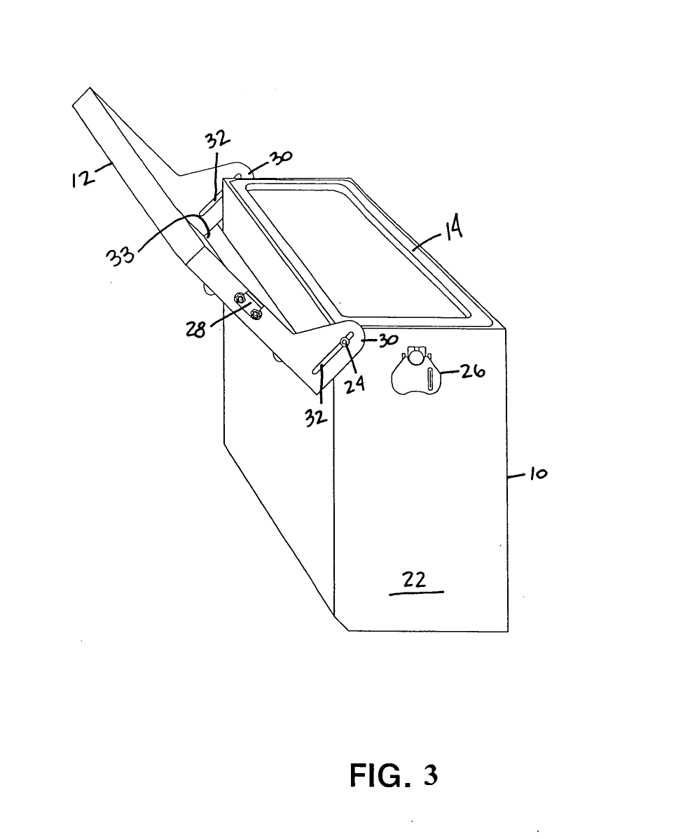

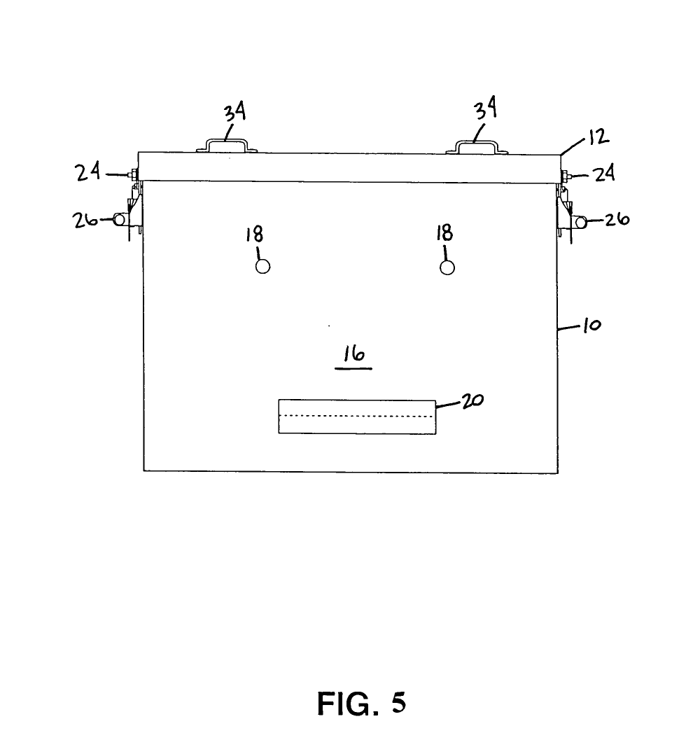

The top of the containment body (10) has a central opening, as seen in FIG. 3, for depositing items into or removing items from the inside space of the containment body (10). The open top of the body (10) includes a rubber sealing strip (14) around the perimeter of the opening, which extends above, around, and below the edge of the perimeter of the opening. When the lid (12) is placed over the opening, against the rubber sealing strip (14), a tight seal is formed. This protects the contents inside the containment body (10) from water, wind, or dust damage. The containment body (10) is mountable to a recreational vehicle such as a motorcycle, boat, or pickup truck. FIG. 5 shows one vertical side wall (16) of the containment body (10), with two holes (18) drilled through it for the purpose of connecting bolts to the vehicle in use. Alternatively, the containment body (10) may be attached to a vehicle in other ways, such as quick-release pressure cams, bolts attached to the frame, bolts attached to a support extending from the frame, bolts attached to the fender, the containment body could be draped over the vehicle and secured by strapping material, or an adhesive material or Velcro could potentially be used.

An arm (20), also known as an L-block or shear block, may also be attached toward the bottom edge of the side wall, for supporting against a rail on the vehicle. The arm (20) supports the shear hanging weight of the box as it is mounted on a vehicle. The two vertical ends (22) have hinges (24) in the top corner, along the edge opposite the side (16) that is mounted to the vehicle. Each hinge (24) has a sleeve over it to allow for easy glide movement, which acts as a bearing surface. The vertical ends (22) also have top, center cam locks (26) that connect with latch hooks (28), or keepers, on the lid (12) for ensuring a tight connection against the rubber sealing strip (14). The position of the cam locks (26) on the containment body (10) must be in a location that allows for a clamping effect of the lid (12), in order to provide a tight seal against the rubber sealing strip (14). The cam locks (26) have a provision for attaching a padlock, if desired.

The lid (12) has two vertical side walls, two vertical ends, and one horizontal top wall, that are joined together at their edges, and made of metal or other similarly durable material. The lid (12) is adapted to fit over and around the top of the containment body (10). The two vertical ends have extended tabs (30) along one edge that include vertically extending cut-out slots (32). The cut-out slots (32) extend around the hinges (24) in the vertical ends (22) of the containment body (10) to form a slide-hinge.

The lid (12) is able to raise vertically above one side the containment body (10) for the distance allowed by the hinge (24) and cut-out slot arrangement, then pivot over to the other side of the containment body (10), depicted in FIG. 3, for ease in packing and retrieving objects inside the box. With this type of slide-hinge feature is it possible to raise the lid (12) vertically a short distance and place small items into the containment body (10) without having to pivot the lid (12) completely or swing the lid (12) into potential traffic. This feature also allows the user to remove and position the lid (12) out of the way without the lid (12) becoming completely detached from the containment body (10), thus preventing the lid (12) from becoming misplaced, forgotten, stolen, or otherwise separated and lost. Additionally, in contrast to a standard piano hinge, the slide-hinge allows for the lid (12), when it is fully open, to rest against the side of the containment body (10) at an angle to the body (10), thus creating a receiving space (33) for conveniently resting keys and other small items while the user packs the box.

The ends of the lid (12) include center latch hooks (28) that connect with the top, center cam locks (26) on the ends (22) of the containment body (10). The horizontal top wall of the lid (12) includes four metal loops (34) bolted to the top wall, each aligned parallel with the side walls of the lid (12). The loops (34) are positioned in each corner of the top wall of the lid (12) for passing strapping material, such as rope or webbing, through the loops (34) and strapping additional objects to the top of the box. Alternatively, the loops (34) could be replaced with a plate.

Although this invention has been described above with reference to particular means, materials and embodiments, it is to be understood that the invention is not limited to these disclosed particulars, but extends instead to all equivalents within the scope of the following claims.

What is claimed is:

1. A storage container for a vehicle comprising a body and a lid;
wherein the body has two sides, two ends, one bottom, and one top;
wherein the body has a means for securement to a vehicle;
wherein the top of the body has an opening with a sealing strip around the perimeter edge of the opening;
wherein the body has hinges, one on each end near the top;
wherein the lid has two sides, two ends, and one top;
wherein the lid has a lock device for cooperating with the body, and the lid has an extended tab along an edge of each end;
wherein the extended tabs include cut-out slots that cooperate with, and extend around, the hinges in the ends of the body.

2. The invention as claimed in claim 1, wherein the lid rests against a side of the body, and has a receiving space for supporting objects when it is fully open.

3. The invention as claimed in claim 1, wherein the top of the lid includes loops.
